(19) United States
(12) Patent Application Publication
(10) Pub. No.: US 2025/0021347 A1
(43) Pub. Date: Jan. 16, 2025

(54) JAVASCRIPT LIBRARY ISOLATION

(71) Applicant: VMware LLC, Palo Alto, CA (US)

(72) Inventor: Nikola Vladimirov Iliev, Sofia (BG)

(73) Assignee: VMware LLC, Palo Alto, CA (US)

(21) Appl. No.: 18/221,734

(22) Filed: Jul. 13, 2023

(51) Int. Cl. G06F 9/445; G06F 8/65; G06F 8/71; G06F 9/451

(52) U.S. Cl. CPC G06F 9/44526; G06F 8/65; G06F 8/71; G06F 9/451

(57) ABSTRACT

JavaScript library isolation can include replacing instances of a read/write call to a particular object from JavaScript code of a user interface (UI) plugin to a hosting application with a proxy as the JavaScript code is compiled to a JavaScript file, defining a function by which the proxy operates, directing a first subset of read/write calls to the particular object in runtime according to the function, and redirecting a second subset of read/write calls to a different object in runtime according to the function.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

A cloud services platform can deliver secure, isolated, and elastic virtual data center compute, network, storage, and security in a self-service model. The cloud services platform can be used to partition and manage first party cloud services on third party resource pools and made available to tenants through an on-demand self-service model in a securely isolated multitenant environment. The cloud services platform can be used to build secure multitenant clouds by pooling virtual infrastructure resources into virtual data centers. The clouds can be exposed to tenants by using web-based portals and programmatic interfaces as a fully automated catalog-based service. A user can interact with the cloud services platform via a cloud services platform user interface (UI).

### BRIEF DESCRIPTION OF THE DRAWINGS

FIG. 1 is a diagram of a system for JavaScript library isolation.

FIG. 2 is a compile time method flow diagram for JavaScript library isolation.

FIG. 3 is a runtime method flow diagram for JavaScript library isolation.

FIG. 4 is a method flow diagram for JavaScript library isolation.

### DETAILED DESCRIPTION

A cloud services platform can incorporate user interface (UI) plugins. Once written, it would be desirable for the UI plugins to remain working for multiple versions of the cloud services platform. The multiple versions of the cloud services platform may be released over many years, which is a long time with respect to the UI plugins.

The UI plugins that operate within the cloud services platform UI may borrow JavaScript library dependencies at runtime to reduce the file size of the UI plugin itself. The UI plugins can reuse JavaScript libraries provided by the cloud services platform.

However, when the cloud services platform switches to a new version of a JavaScript library that is shared with the UI plugins, the UI plugins face a risk of working. Browser script code is computer instructions that can cause a web browser to function. One example of browser script is JavaScript. JavaScript is a high level (often just-in-time compiled) programming language that is heavily used with respect to the world wide web alongside hypertext markup language (HTML) and cascading style sheets (CSS). Websites often use JavaScript on the client side for webpage behavior, often incorporating third party libraries. Web browsers typically include a JavaScript engine to execute JavaScript code on user devices. JavaScript includes dynamic typing, prototype-based object orientation, and first class functions. JavaScript includes application programming interfaces (APIs) for working with text, dates, regular expressions, standard data structures, and the document object model (DOM). TypeScript is an open source high level programming language that adds static typing with optional type annotations to JavaScript. TypeScript is designed for the development of large applications and transpiles (translates source code of one programming language to source code of another programming language) to JavaScript. JavaScript programs are syntactically valid TypeScript, but they can fail to type-check for safety reasons. Some previous approaches do not permit multiple versions of a JavaScript library to be used simultaneously in a browser.

Each JavaScript library or script in some way uses a global window object of the browser, for example, to preserve state, register classes or functions, etc. The browser object model (BOM) allows JavaScript to interact with the browser. The window object represents an open window in the browser. JavaScript objects, functions, and variables automatically become members of the window object. If a document contains frames, such as inline frames (iframes), the browser can create one window object for an HTML document and one additional window for each frame. An iframe is used to embed another document within a current HTML document. The iframe can be used to set height and width (specified in pixels) by default. If two (or more) versions of the JavaScript library are used together in a browser, they may have a conflict with each other on the JavaScript global window object level.

One or more embodiments of the present disclosure address the above and other deficiencies to enable a cloud services platform UI to support multiple versions of a JavaScript library to run simultaneously in a browser without conflict (e.g., for different states, classes, or functions having a same name between the multiple versions of the JavaScript library). Therefore, stable backwards compatibility with respect to the UI plugins can be provided.

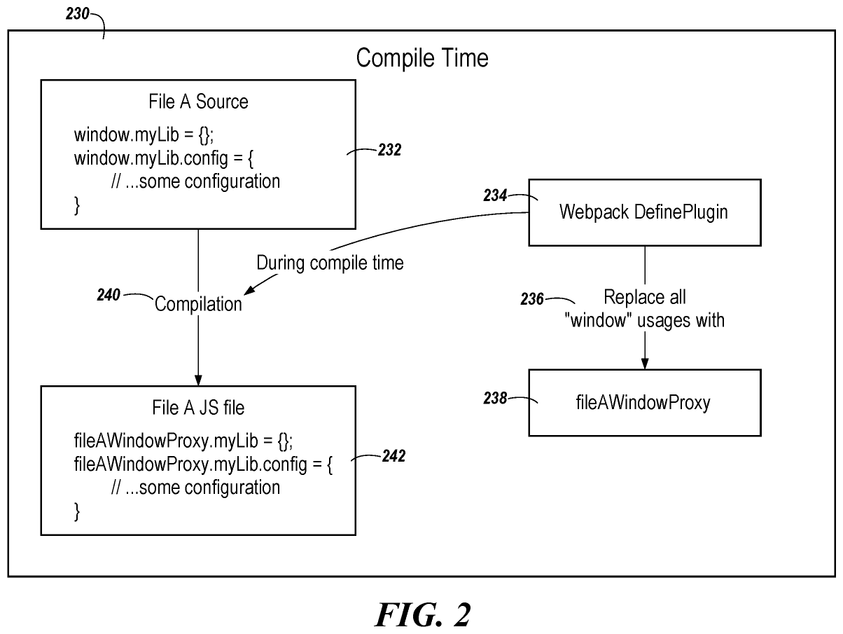

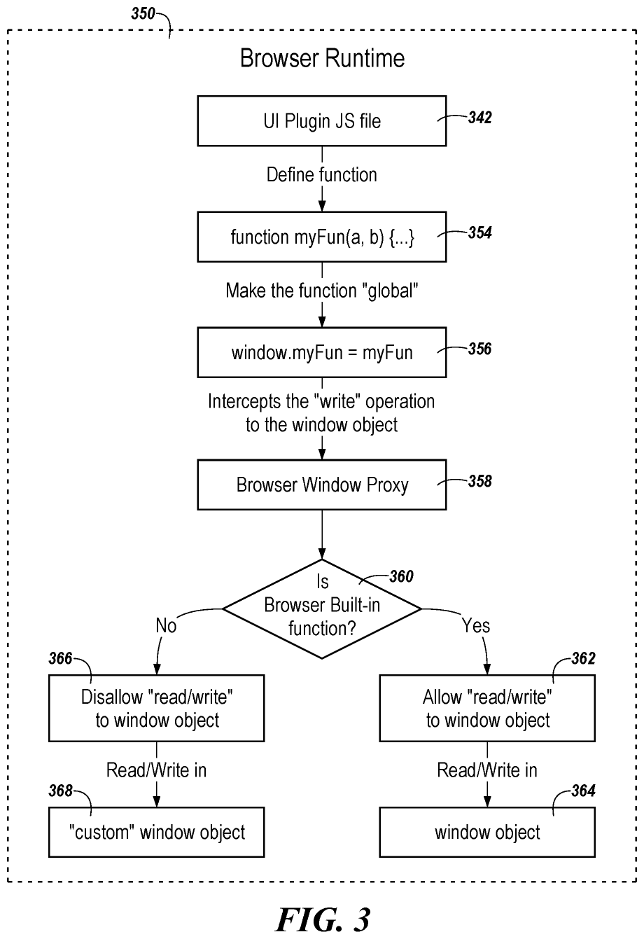

The figures herein follow a numbering convention in which the first digit or digits correspond to the drawing figure number and the remaining digits identify an element or component in the drawing. Similar elements or components between different figures may be identified by the use of similar digits. For example, element 242 identifies element “42” in FIG. 2 and a similar element is identified as 342 in FIG. 3. A group or plurality of similar elements or components may generally be referred to herein with a single element number. For example, a plurality of reference elements 124-1, 124-2 may be referred to generally as 124. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

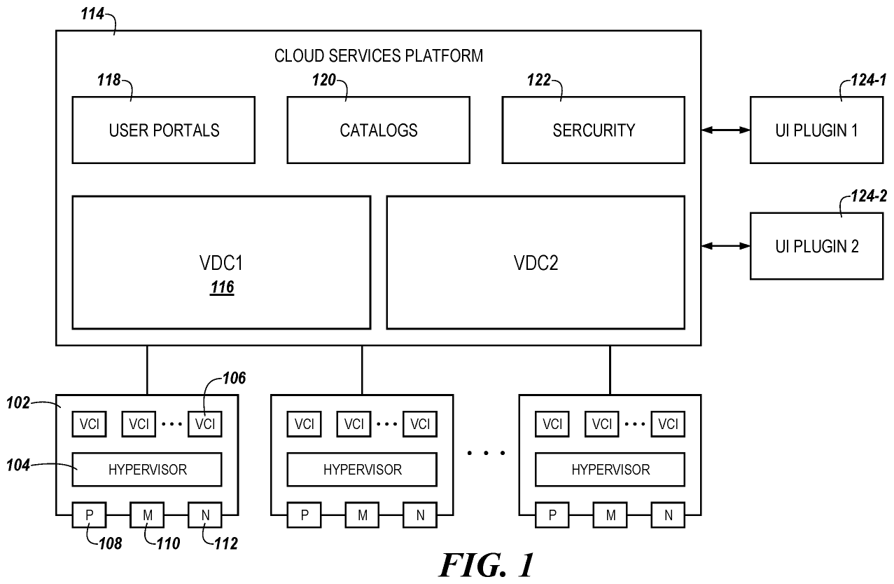

FIG. 1 is a diagram of a system for JavaScript library isolation. The system can include a number of hosts 102. The hosts 102 can be provisioned with processing resource(s) 108 (e.g., one or more processors), memory resource(s) 110 (e.g., one or more main memory devices and/or storage memory devices), and/or a network interface 112. The hosts 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

Memory resources 110 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media. The memory resources 110 can be machine readable media that can store program instructions (e.g., machine-readable instructions) to implement a particular function (e.g., an action such as providing CSS library isolation, as described herein). The set of instructions can be executable by one or more of the processing resources 108.

The processing resources 108 can be coupled to the memory resources 110 via a communication path. The communication path can be local or remote to the host 102. Examples of a local communication path can include an electronic bus internal to a machine, where the memory resources 110 are in communication with the processing resources 108 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path can be such that the memory resources 110 are remote from the processing resources 108, such as in a network connection between the memory resources 110 and the processing resources 108. That is, the communication path can be a network connection. Examples of such a network connection can include a local area network (LAN), wide area network (WAN), personal area network (PAN), and the Internet, among others.

The hosts 102 can incorporate respective hypervisors 104 that can execute a number of virtual computing instances VCIs 106. The VCIs can be provisioned with processing resources 108 and/or memory resources 110 and can communicate via the network interface 112. The processing resources 108 and the memory resources 110 provisioned to the VCIs 106 can be local and/or remote to the hosts 102 (e.g., the VCIs 106 can be ultimately executed by hardware that may not be physically tied to the VCIs 106). For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106.

The hosts 102 can be coupled to a cloud services platform 114. The cloud services platform 114 can pool and allocate the resources provided by the hosts 102 among different customers, departments, and/or virtual data centers (VDCs) 116. VDCs 116 allow service providers to simplify, reorganize, and group hosts 102 in a multitenant fashion. VDCs 116 can be split into various organizations, which can further be split into groups and managed with permissions. For example, a particular company can be assigned its own VDC 116 where it can provision virtualized applications, VCIs 106, and virtual storage. Virtual networks can be set up with routers, switches, and firewalls.

The cloud services platform 114 can provide user portals 118 that can be used by organization administrators to manage the organization's use of the VDCs 116, VCIs 106, virtualized applications, networks, etc. The user portals 118 can allow use of catalogs 120, virtualized application and/or VDC 116 templates, and cross-VDC networks, among other functionality. The cloud services platform 114 can allow administrators and catalog authors to create catalogs 120 for their organization. The catalogs 120 can store virtualized application templates and media files. The catalogs 120 can be shared with other users within the organization and/or published externally. The catalogs 120 can be made private, shared, or externally available. The cloud services platform 114 can provide a broad range of security 122, such as malware prevention, firewalls, dynamic group and membership criteria, encrypted workloads, intrusion detection, intrusion prevention, centralized data collection and analytics, disaster recovery, etc.

A user portal 118 can be accessed via a UI plugin 124. According to at least one embodiment, the cloud services platform 114 can support multiple versions of UI plugins, such as a first UI plugin 124-1 and a second UI plugin 124-2. The UI plugins 124 can be configured to allow users to access information and/or services provided by the cloud services platform 114. The user can be presented with a welcome page in a UI of the cloud services platform 114, or via a separate browser. Either option can be used to access features of the cloud services platform 114 that are available to the user.

The cloud services platform 114 can replace instances of a read/write call to a particular object from JavaScript code of a first version of a UI plugin 124-1 to the cloud services platform 114 with a proxy as the JavaScript code of the first version of the UI plugin 124-1 is compiled. The cloud services platform 114 can replace instances of the read/write call to the particular object from JavaScript code of a second version of a UI plugin 124-2 to the cloud services platform 114 with the proxy as the JavaScript code of the second version of the UI plugin 124-2 is compiled. The cloud services platform 114 can define a function by which the proxy operates. The cloud services platform 114 can direct a first subset of read/write calls from the first version and the second version of the UI plugin to the particular object in runtime according to the function. The cloud services platform 114 can redirect a second subset of read/write calls from the first version and the second version of the UI plugin to a different object in runtime according to the function. By way of example, the first subset of read/write calls can be read/write read/write calls originally directed to a browser window resource having functionality built into the browser. The different object can be a separate application in the browser window. The cloud services platform can perform the above tasks analogously for a third, fourth, or any additional number of versions of the UI plugins. In some embodiments, the function dictates that all read/write calls from any version of the UI plugin developed for a same version of a JavaScript library as the hosting application be directed to the particular object. In some examples, the first version of the UI plugin 124-1 was developed for a previous version of the cloud services platform 114 that included a different JavaScript library than a current version of the cloud services platform 114. The cloud services platform 114 can present a browser window to a user of the first version of the UI plugin 124-1 without conflict for different states, classes, or functions having a same name between the different versions of the JavaScript library.

As referred to herein, VCI covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

VCIs have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

FIG. 2 is a compile time 230 method flow diagram for JavaScript library isolation. JavaScript source code 232 of any UI plugin (e.g., UI plugin 124-1 illustrated in FIG. 1) can be preprocessed in compile time. The build process of the UI plugin can be hooked using a plugin as illustrated at 234 (e.g., Webpack Define Plugin). Instances of a read/write call to a particular object from JavaScript source code 232 of each UI plugin can be replaced 236 with a proxy 238 as the JavaScript code 232 is compiled 240 to a JavaScript file 242. Stated differently, any keyword from the JavaScript source code 232 can be replaced with a variable as the JavaScript source code 232 is compiled 240 to the JavaScript file 242. The particular object can be an object for which it is believed that different versions of the JavaScript library may cause issues, such as a browser window object.

As illustrated at 232, in this example, the read/write call includes “window.myLib”, which indicates a read/write call to a window object. Instances of the read/write call to the window object can be replaced with a proxy 238 (e.g., for any read/write call including the keyword “window”, the keyword can be replaced with a variable). The proxy 238 (variable) in this example is “fileAWindowProxy”, with replaces the keyword in the read/write call in the compiled JavaScript file 242. This enables the read/write call to be intercepted. The functionality of the proxy 238 (a value of the variable) can be defined and/or available at runtime.

As illustrated at 232, 238, and 242 the portions from the JavaScript source code 232 “window.myLib={ }” and “window.myLib.config={// . . . some configuration}” is replaced with such that the JavaScript file 242, after being compiled, includes “fileAWindowProxy” “fileAWindowProxy.myLib={ }” and “fileAWindowProxy.myLib.config={// . . . some configuration}”. The proxy will be available (in runtime) to intercept read/write calls to the window and redirect (or not) as desired. A condition can be set to determine whether or not such read/write calls are redirected (e.g., whether the read/write calls are allowed to access a certain browser window resource).

FIG. 3 is a runtime 350 method flow diagram for JavaScript library isolation. The runtime 350 method flow diagram essentially picks up where the compile time 230 flow diagram illustrated in FIG. 2 left off, with the compiled JavaScript file 342 of the UI plugin. The runtime 350 can be the runtime of the browser. The example of the hosting application used herein is a cloud services platform UI, however embodiments are not so limited. It may be desirable to intercept read/write calls that are originally directed to the window object and redirect those read/write calls to another object. At runtime 350, the proxy 358 (“Browser Window Proxy”) can be initiated to intercept such read/write calls and redirect as necessary.

At 354, a function (“function myFun(a, b) { . . . }”) can be defined by which the proxy 358 operates. In some embodiments, and as illustrated at 356, the function can be made global (“window.myFun=myFun”). For example, the function can define a condition for whether intercepted read/write calls are directed to their originally intended object or to another object. A non-limiting example of such a condition is illustrated in FIG. 3 at 360 as “is browser built-in function?”. This example of a condition is explained in more detail below. Another example of the condition is whether the read/write call came from a UI plugin that uses a same version of the JavaScript library as the hosting application and/or browser. In one instance, read/write calls that satisfy the condition are allowed to read/write to the window object 364 as illustrated at 362. In another instance, read/write calls that do not satisfy the condition are disallowed to read/write to the window object, as illustrated at 366. Such read/write calls can be redirected to a “custom” window object, as illustrated at 368.

The proxy 358 can direct a first subset of read/write calls to the particular object (as illustrated at 360, 362, and 364) in runtime 350 according to the function. In some examples, the first subset of read/write calls may be directed to the particular object (allowed to proceed to their originally intended object) if the read/write calls were originally directed to a browser window object having functionality built into the browser. In such an example, because the functionality is built into the browser itself, the concern of problems arising from conflicting versions of the JavaScript library may not be an issue. As another example, the first subset of read/write calls may be directed to the particular object if the read/write calls are from a UI plugin that is using a same version of the JavaScript library as the hosting application and/or the browser. In this example, there would be no conflict in the JavaScript library because the same version is being used by host and client.

The proxy 358 can direct a second subset of read/write calls to a different object in runtime 350 according to the function (as illustrated at 360, 366, and 368). The different object can be an object other than the browser window, such as a separate application in the browser window. Redirecting read/write calls that were originally intended for the browser window object, but are from a UI plugin using a different version of the JavaScript library, to a different object can prevent a clash between different versions of the JavaScript library. Such a clash could cause an error, such as a function not executing properly or at all. As another example, different functions could have the same name in different versions of the JavaScript library. In this example, if the read/write call was allowed to proceed to the browser window object, it could cause an unintended function to be executed, thereby doubling the problem (the intended function not being executed, and an unintended function being executed). As such, the use of multiple versions of the JavaScript library can be supported by the hosting application simultaneously in the browser.

Some previous approaches may include the use of JavaScript closures. JavaScript variables can have a local or global scope. Global variables can be made local (e.g., private) with closures. A function can access variables defined inside the function and/or outside the function. In a webpage, variables belong to the page. Global variables can be used and changed by all other scripts on the page. Local variables can only be used inside the function where it is defined. Global and local variables having the same name are different variables and may not conflict (e.g., modifying one does not modify the other). A JavaScript closure is a function that has access to variables a parent function even after the parent function has closed. The closure can be used to prevent one or more variables of the parent function from being accessed outside of the parent function, thereby potentially making a global variable private and preventing conflict between different variables having the same name. However, while closures consider the JavaScript code, they do not consider the window state. For example, if a global window object variable is defined in JavaScript library A, JavaScript library B (a different library) will also have access to it and may conflict. Thus, closures do not solve the problems solved by embodiments of the present disclosure, which allow multiple versions of a JavaScript library to be supported simultaneously in a browser.

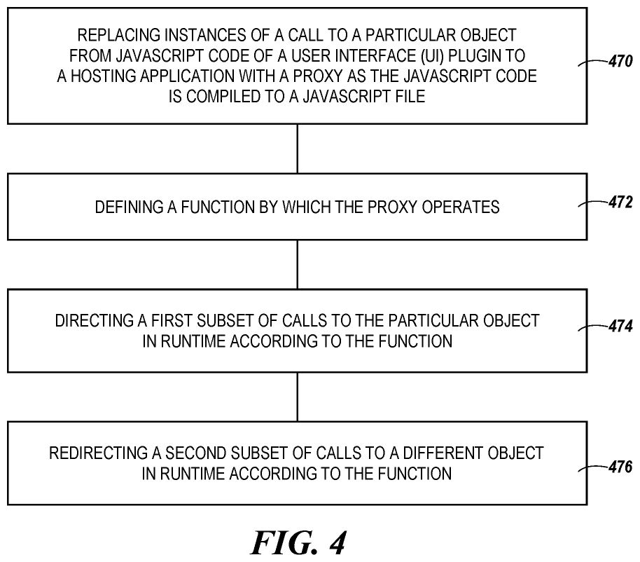

FIG. 4 is a method flow diagram for JavaScript library isolation. The method may be performed, in some examples, using a system such as described with respect to FIG. 1. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the cloud services platform 114 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 470, the method can include replacing instances of a read/write call to a particular object from browser script (e.g., JavaScript) code of a UI plugin to a hosting application with a proxy as the JavaScript code is compiled to a browser script (e.g., JavaScript) file. One example of the hosting application is a cloud services platform UI. The UI plugin can borrow JavaScript library dependencies from the cloud services platform UI.

At 472, the method can include defining a function by which the proxy operates. The definition can occur in runtime. The function can be made global to the particular object.

At 474, the method can include directing a first subset of read/write calls to the particular object in runtime according to the function. Runtime can refer to browser runtime. The particular object can be a browser window object. In some embodiments, the first subset of read/write calls were originally directed to a browser window resource having functionality built into the browser.

At 476, the method can include redirecting a second subset of read/write calls to a different object in runtime according to the function. The different object can be a separate application in the browser window. In some embodiments, the second subset of read/write calls are those other than the read/write calls originally directed to the browser window resource having functionality built into the browser itself. Although not specifically illustrated in FIG. 4, the method can be performed for many different UI plugins and many different versions of the UI plugins for one instance of a hosting application and/or one JavaScript library, thereby providing backward compatibility for the hosting application and/or JavaScript library without causing errors for different users (e.g., conflict for different states, classes, or functions having a same name between the multiple versions of the JavaScript library).

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
replacing instances of a read/write call to a particular object from browser script code of a user interface (UI) plugin to a hosting application with a proxy as the browser script code is compiled to a browser script file;
defining a function by which the proxy operates;
directing a first subset of read/write calls to the particular object in runtime according to the function; and
redirecting a second subset of read/write calls to a different object in runtime according to the function.

2. The method of claim 1, further comprising making the function global to the particular object.

3. The method of claim 1, wherein the runtime comprises runtime of a browser;
wherein the particular object comprises a browser window object;
wherein the different object comprises a separate application in the browser window.

4. The method of claim 3, wherein the first subset of read/write calls were originally directed to a browser window resource having functionality built into the browser.

5. The method of claim 4, wherein the second subset of read/write calls comprise read/write calls other than those originally directed to the browser window resource having functionality built into the browser.

6. The method of claim 1, wherein the hosting application comprises a cloud services platform UI; and
wherein the method further comprises borrowing, by the UI plugin, JavaScript library dependencies from the cloud services platform UI.

7. The method of claim 6, further comprising supporting multiple versions of the JavaScript library simultaneously in a browser without causing a conflict for different states, classes, or functions having a same name between the multiple versions of the JavaScript library.

8. The method of claim 1, comprising defining the function at runtime.

9. The method of claim 1, comprising replacing respective instances of the read/write call to the particular object from respective browser script code of each of a plurality of versions of the UI plugin with the proxy as the respective JavaScript code is compiled to respective browser script files.

10. A non-transitory machine-readable medium having instructions stored thereon which, when executed by a processor, cause the processor to:
replace instances of a read/write call to a particular object from JavaScript code of a first version of a user interface (UI) plugin to a hosting application with a proxy as the JavaScript code of the first version of the UI plugin is compiled;
replace instances of the read/write call to the particular object from JavaScript code of a second version of a UI plugin to the hosting application with the proxy as the JavaScript code of the second version of the UI plugin is compiled;
define a function by which the proxy operates;
direct a first subset of read/write calls from the first version and the second version of the UI plugin to the particular object in runtime according to the function; and
redirect a second subset of read/write calls from the first version and the second version of the UI plugin to a different object in runtime according to the function.

11. The medium of claim 10, further comprising instructions to:
replace instances of the read/write call to the particular object from JavaScript code of a third version of a UI plugin to the hosting application with the proxy as the JavaScript code of the third version of the UI plugin is compiled;
direct all read/write calls from the third version of the UI plugin to the particular object in runtime according to the function.

12. The medium of claim 10, wherein the function dictates that all read/write calls from any version of the UI plugin developed for a same version of a JavaScript library as the hosting application be directed to the particular object.

13. The medium of claim 12, wherein the first version and the second version of the UI plugin were developed for different versions of the JavaScript library than the hosting application.

14. The medium of claim 10, wherein the first subset of read/write calls comprise read/write read/write calls originally directed to a browser window resource having functionality built into the browser; and
wherein the different object comprises a separate application in the browser window.

15. The medium of claim 10, wherein the first version of the UI plugin was developed for a first version of a JavaScript library;
wherein the hosting application uses a second version of the JavaScript library; and
further comprising instructions to present, by the hosting application, a browser window to a user of the first version of the UI plugin without conflict for different states, classes, or functions having a same name between the first and the second versions of the JavaScript library.

16. A system, comprising:
processing and memory resources configured to:
provide a cloud services platform user interface (UI);
support a plurality of versions of a UI plugin hosted by the cloud services platform UI with a current version of a JavaScript library of the cloud services platform UI;
replace instances of a read/write call to a particular object from JavaScript code of each UI plugin to the cloud services platform UI with a proxy as the JavaScript code is compiled to a JavaScript file;
define a function by which the proxy operates;
direct a first subset of read/write calls to the particular object in runtime according to the function; and
redirect a second subset of read/write calls to a different object in runtime according to the function.

17. The system of claim 16, wherein the runtime comprises runtime of a browser; and
wherein the particular object comprises a browser window object; and
wherein the different object comprises an object other than the browser window.

18. The system of claim 17, wherein the different object comprises a separate application in the browser window; and
wherein the first subset of read/write calls were originally directed to a browser window resource having functionality built into the browser.

19. The system of claim 16, wherein the processing and memory resources are further configured to support the use of multiple versions of the JavaScript library by the plurality of versions of a UI plugin simultaneously in a browser.

20. The system of claim 19, wherein the processing and memory resources are further configured to make the function global to the particular object.
